(19) United States
(12) Patent Application Publication
(10) Pub. No.: US 2025/0138317 A1
(43) Pub. Date: May 1, 2025

(54) NEAR-EYE DISPLAY APPARATUS, DISPLAY METHOD THEREOF AND WEARABLE DEVICE

(71) Applicants: Beijing BOE Display Technology Co., Ltd., Beijing (CN); BOE Technology Group Co., Ltd., Beijing (CN)

(72) Inventors: Yulong WU, Beijing (CN); Lili CHEN, Beijing (CN); Hao ZHANG, Beijing (CN); Ruijun DONG, Beijing (CN); Chenru WANG, Beijing (CN); Na HAN, Beijing (CN)

(21) Appl. No.: 18/705,604

(22) PCT Filed: Aug. 9, 2023
(86) PCT No.: PCT/CN2023/111940

§ 371 Date: Apr. 29, 2024

(30) Foreign Application Priority Data
Aug. 31, 2022 (CN) 202211060771.0

(51) Int. Cl. G02B 27/01; G02B 1/115; G02B 5/02

(52) U.S. Cl. CPC G02B 27/0172; G02B 1/115; G02B 5/0294; G02B 2027/011; G02B 2207/101

(57) ABSTRACT

A near-eye display apparatus, a display method thereof and a wearable device. The near-eye display apparatus comprises: at least one first display unit (31), the first display unit (31) being configured to form at an imaging position a first image; at least one second display unit (32), the second display unit (32) being configured to form at the imaging position a second image, the first image and the second image being spliced to form a display image; and an optical path adjustment structure (5), the optical path adjustment structure (5) being configured to transmit towards the direction of the imaging position at least part of emergent light rays of the first display unit (31), and to reflect towards the direction of the imaging position at least part of emergent light rays of the second display unit (32).

### CROSS-REFERENCE TO RELATED APPLICATION

The present application is a U.S. National Phase Entry of International Application No. PCT/CN2023/111940 having an international filing date of Aug. 9, 2023, which claims priority from Chinese Patent Application No. 202211060771.0, filed to the CNIPA on Aug. 31, 2022. Contents of the above-identified applications are incorporated into the present application by reference.

### TECHNICAL FIELD

The present disclosure relates to, but is not limited to, the field of display technologies, and particularly to a near-eye display apparatus and a display method thereof, and a wearable device.

### BACKGROUND

A near-eye display apparatus is also called a helmet display. With a rapid development of near-eye display technology, Virtual Reality (VR), Augmented Reality (AR) and Mixed Reality (MR) have increasingly become important ways for human beings to obtain information, and also become new ways for human beings to interact with the world.

Through the near-eye display apparatus, such as VR glasses and VR helmets, images can be directly projected into the eyes of viewers, thus achieving an immersive display experience.

Application fields of the near-eye display apparatus have gradually expanded from an initial military field to such fields as games, film and television entertainment, live broadcast, real estate, retail, education, medical and health care. Augmented reality technology superimposes virtual image information on a real environment, and then receives it by human eyes. It requires a head-mounted optical display system to have the characteristics of small weight, small volume, clear image and large field angle of view and the like, which puts forward requirements for an optical display mode of an optical system.

### SUMMARY

The following is a summary of subject matter described herein in detail. This summary is not intended to limit the protection scope of the claims.

In a first aspect, an embodiment of the present disclosure provides a near-eye display apparatus, including:
at least one first display unit, wherein the first display unit extends along a first direction and the first display unit is configured to form a first image at an imaging position;
at least one second display unit, wherein the second display unit extends along a second direction and the second display unit is configured to form a second image at the imaging position; the first direction is different from the second direction;
the first image and the second image are spliced to form a display image;
an optical path adjustment structure, wherein at least a portion of the optical path adjustment structure is located on an optical path of outgoing light from the first display unit and on an optical path of outgoing light from the second display unit, the optical path adjustment structure is configured to transmit at least a portion of the outgoing light from the first display unit in a direction toward the imaging position, and reflect at least a portion of the outgoing light from the second display unit in the direction toward the imaging position.

In an exemplary implementation, the first image has a first border area close to the second image adjacent thereto, the second image has a second border area close to the first image adjacent thereto, there is an overlapping area between the first border area and the second border area, and an image displayed in the overlapping area of the first border area is the same as an image displayed in the overlapping area of the second border area.

In an exemplary implementation, the first image has a first edge close to the second image adjacent thereto, the second image has a second edge close to the first image adjacent thereto, and the first edge is adjacent to the second edge so that the first image and the second image are seamlessly spliced.

In an exemplary implementation, the optical path adjustment structure includes at least one semi-transmissive and semi-reflective region, the semi-transmissive and semi-reflective region is located on an optical path of at least a portion of the outgoing light from the first display unit and on an optical path of at least a portion of the outgoing light from the second display unit, the semi-transmissive and semi-reflective region is configured to transmit at least a portion of the outgoing light from the first display unit in the direction toward the imaging position and reflect at least a portion of the outgoing light from the second display unit in the direction toward the imaging position.

In an exemplary implementation, the optical path adjustment structure further includes at least one reflective region, the reflective region is located on a side of the semi-transmissive and semi-reflective region, the reflective region is located on the optical path of at least a portion of the outgoing light from the second display unit, and the reflective region is configured to reflect at least a portion of the outgoing light from the second display unit in the direction toward the imaging position.

In an exemplary implementation, the optical path adjustment structure further includes at least one transmissive region, the transmissive region is located on a side of the semi-transmissive and semi-reflective region away from the reflective region, the transmissive region is located on the optical path of at least a portion of the outgoing light from the first display unit, and the transmissive region is configured to transmit at least a portion of the outgoing light from the first display unit in the direction toward the imaging position.

In an exemplary implementation, the optical path adjustment structure includes a substrate and at least one semi-transmissive and semi-reflective film, at least one reflective film and at least one anti-reflection film disposed on the substrate, the semi-transmissive and semi-reflective film is located in the semi-transmissive and semi-reflective region, the reflective film is located in the reflective region, and the anti-reflection film is located in the transmissive region.

In an exemplary implementation, the semi-transmissive and semi-reflective film is disposed between the reflective film and the anti-reflection film.

In an exemplary implementation, the substrate of the optical path adjustment structure is made of glass or plastic.

In an exemplary implementation, the optical path adjustment structure has a thickness ranging from 1 mm to 5 mm.

In an exemplary implementation, the optical path adjustment structure extends along a third direction and the third direction is different from both the first direction and the second direction.

In an exemplary implementation, a microlens substrate is further included, the microlens substrate includes multiple microlenses, the multiple microlenses are located between the optical path adjustment structure and the imaging position, the multiple microlenses are configured to project at least a portion of outgoing light from the optical path adjustment structure to the imaging position.

In an exemplary implementation, the multiple microlenses include at least one of a spherical lens, an aspherical lens, and a free-form lens.

In an exemplary implementation, the microlens substrate further includes an anti-reflection structure, the anti-reflection structure is disposed on a side of the multiple microlenses close to the optical path adjustment structure; and/or, the anti-reflection structure is disposed on a side of the multiple microlenses away from the optical path adjustment structure.

In an exemplary implementation, a field angle of view of the imaging position is from 100° to 150°.

In an exemplary implementation, both the first display unit and the second display unit include at least one of an organic light emitting diode display unit, a quantum dot light emitting diode display unit, a micro light emitting diode display unit, and a liquid crystal display unit.

In a second aspect, an embodiment of the present disclosure further provides a wearable device, including the aforementioned near-eye display apparatus.

In a third aspect, an embodiment of the present disclosure further provides a display method of a near-eye display apparatus, the near-eye display apparatus includes at least one first display unit, at least one second display unit, and an optical path adjustment structure, wherein an extension direction of the first display unit is different from an extension direction of the second display unit; at least a portion of the optical path adjustment structure is located on an optical path of outgoing light from the first display unit and on an optical path of outgoing light from the second display unit; the display method of the near-eye display apparatus includes:
transmitting at least a portion of the outgoing light from the first display unit through the light path adjustment structure to emit in a direction toward the imaging position, so that the outgoing light from the first display unit forms a first image at the imaging position;
reflecting at least a portion of the outgoing light from the second display unit through the light path adjustment structure to emit in the direction toward the imaging position, so that the outgoing light from the second display unit forms a second image at the imaging position; and
splicing the first image and the second image to form a display image.

Other aspects of the present disclosure may be comprehended after the drawings and the detailed descriptions are read and understood.

### BRIEF DESCRIPTION OF DRAWINGS

Accompanying drawings are used for providing an understanding of technical solutions of the present application and form a part of the specification, are used for explaining the technical solutions of the present application together with embodiments of the present application, and do not constitute a limitation on the technical solutions of the present application.

FIG. 1 is a schematic diagram of a structure of a near-eye display apparatus in the related art.

FIG. 2 is a first schematic diagram of a structure of a near-eye display apparatus according to the present disclosure.

FIG. 3 is a cross-sectional view of a first display unit in a near-eye display apparatus according to an embodiment of the present disclosure.

FIG. 4 is a schematic diagram of a structure of an optical path adjustment structure in a near-eye display apparatus according to an embodiment of the present disclosure.

FIG. 5 is a second schematic diagram of a structure of a near-eye display apparatus according to the present disclosure.

FIG. 6 is a schematic diagram of an optical path in a near-eye display apparatus according to an embodiment of the present disclosure.

### DETAILED DESCRIPTION

To make the objectives, technical solutions, and advantages of the present disclosure clearer, embodiments of the present disclosure will be described in detail below with reference to the drawings. It is to be noted that implementations may be implemented in various forms. Those of ordinary skills in the art can easily understand such a fact that implementations and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of each composition element, a thickness of a layer, or a region may be exaggerated sometimes for clarity. Therefore, an implementation of the present disclosure is not always limited to the size, and the shape and size of each component in the drawings do not reflect an actual scale. In addition, the drawings schematically illustrate ideal examples, and an implementation of the present disclosure is not limited to shapes, numerical values, or the like shown in the drawings.

Ordinal numerals “first”, “second”, “third” and the like in the specification are set not to form limits in numbers but only to avoid confusion between composition elements.

In the specification, for convenience, expressions “central”, “above”, “below”, “front”, “back”, “vertical”, “horizontal”, “top”, “bottom”, “inside”, “outside” and the like for indicating directional or positional relationships are used to illustrate positional relationships between the composition elements with respect to the drawings, which are only for the convenience of describing the specification and simplifying the description, and do not indicate or imply that involved devices or elements are required to have specific orientations, are structured and operated in the specific orientations, and thus should not be understood as limitations on the present disclosure. The positional relationships between the composition elements may be changed as appropriate according to a direction in which each composition element is described. Therefore, appropriate replacements based on situations are allowed, the positional relationships are not limited to the expressions in the specification.

In the specification, unless otherwise expressly specified and defined, terms “mounting”, “connection”, and “join” should be understood in a broad sense. For example, it may be a fixed connection, or a detachable connection, or an integral connection; it may be a mechanical connection or an electrical connection; it may be a direct connection, or an indirect connection through an intermediate, or an internal communication between two elements. Those of ordinary skills in the art can understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, a first electrode may be a drain electrode, and a second electrode may be a source electrode. Alternatively, the first electrode may be a source electrode, and the second electrode may be a drain electrode. In cases that transistors with opposite polarities are used, or a current direction changes during operation of a circuit, or the like, functions of the “source electrode” and the “drain electrode” are sometimes interchangeable. Therefore, the “source electrode” and the “drain electrode” are interchangeable in the specification.

In the specification, “electrical connection” includes connection of composition elements through an element with a certain electrical action. An “element with a certain electrical action” is not particularly limited as long as electric signals may be sent and received between the connected composition elements. Examples of the “element with a certain electrical action” not only include an electrode and a wiring, but also include a switch element such as a transistor, a resistor, an inductor, a capacitor, another element with various functions, etc.

In the specification, “parallel” refers to a state in which an angle formed by two straight lines is −10° or more and 10° or less, and thus also includes a state in which the angle is −5° or more and 5° or less. In addition, “perpendicular” refers to a state in which an angle formed by two straight lines is 80° or more and 100° or less, and thus also includes a state in which the angle is 85° or more and 95° or less.

In the specification, a “film” and a “layer” are interchangeable. For example, a “conductive layer” may be replaced with a “conductive film” sometimes. Similarly, an “insulation film” may be replaced with an “insulation layer” sometimes.

In the present disclosure, “about” means that a boundary is not defined so strictly and numerical values within a range of process and measurement errors are allowed.

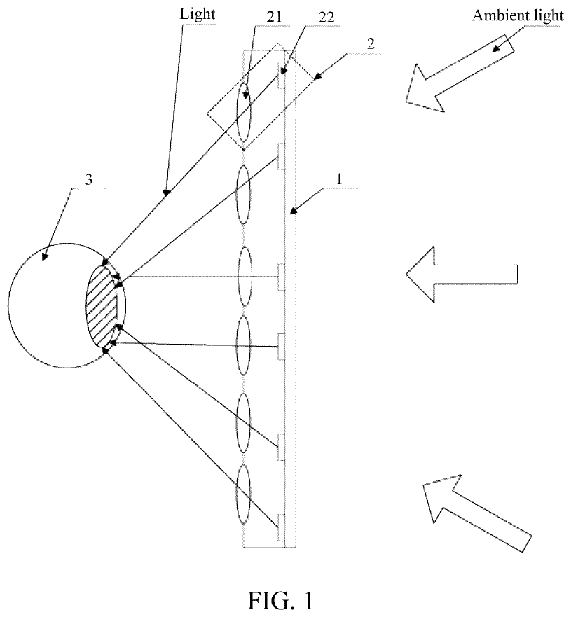

FIG. 1 is a schematic diagram of a structure of a near-eye display apparatus in the related art. As shown in FIG. 1, the near-eye display apparatus includes a base 1, multiple display units 22 disposed on the base 1, and multiple microlenses 21 disposed on a side of the base 1, and the multiple display units 22 are disposed between the base 1 and the multiple microlenses 21. Herein, each display unit 22 is equivalent to a small display screen. The microlenses 21 and the display units 22 are in one-to-one correspondence, and light emitted by a display unit 22 passes through a corresponding microlens 21 and then enters a human eye 3, thereby enabling the human eye 3 to see a display image.

According to a research from the inventor, it is found that there is a non-display area (such as a bezel) at a periphery of the display unit 22, so that a complete image formed by the multiple display units 22 cannot be perfectly spliced together, and there is a problem of a splicing gap.

A near-eye display apparatus is provided in an embodiment of the present disclosure, including:
at least one first display unit extending along a first direction and being configured to form a first image at an imaging position;
at least one second display unit extending along a second direction and being configured to form a second image at the imaging position; the first direction being different from the second direction;
the first image and the second image being spliced to form a display image;
an optical path adjustment structure, at least a portion of the optical path adjustment structure being located on an optical path of outgoing light from the first display unit and on an optical path of outgoing light from the second display unit, and the optical path adjustment structure being configured to transmit at least a portion of the outgoing light from the first display unit in a direction toward the imaging position, and reflect at least a portion of the outgoing light from the second display unit in the direction toward the imaging position.

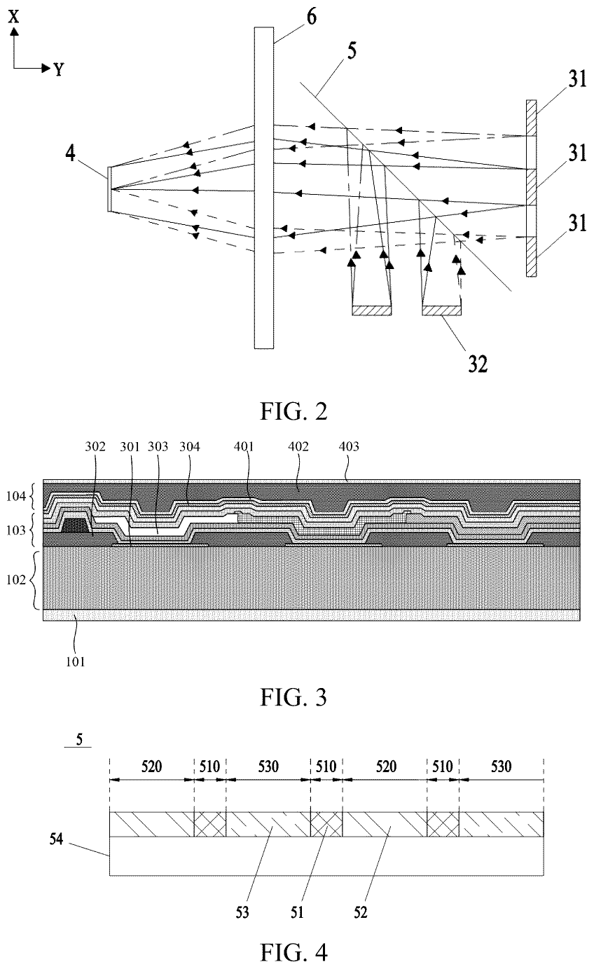

FIG. 2 is a first schematic diagram of a structure of a near-eye display apparatus according to the present disclosure. In an exemplary implementation, as shown in FIG. 2, a near-eye display apparatus according to an embodiment of the present disclosure includes:
at least one first display unit 31, the first display unit 31 extends along a first direction (e.g. direction X), each of the first display units 31 being capable of emitting light in a direction toward an imaging position 4, outgoing light from a first display unit 31 being capable of forming a first image at the imaging position 4, and the first image being a portion of a desired complete display image;
at least one second display unit 32, the second display unit 32 extending along a second direction (e.g. direction Y), and outgoing light from a second display unit 32 being capable of forming a second image at the imaging position 4, the second image being a portion of the desired complete display image; the first direction being different from the second direction; for example, the first direction being perpendicular to the second direction; the first image and the second image being be spliced to form a display image;
an optical path adjustment structure 5, a portion of the optical path adjustment structure 5 being located on an optical path of outgoing light from the first display unit 31, a portion of the optical path adjustment structure 5 being located on an optical path of outgoing light from the second display unit 32, and the optical path adjustment structure 5 being configured to transmit at least a portion of the outgoing light from the first display unit 31 in a direction toward the imaging position 4, and reflect at least a portion of the outgoing light from the second display unit 32 in the direction toward the imaging position 4;
a microlens substrate 6 including multiple microlenses and being positioned between the optical path adjustment structure 5 and the imaging position 4, the microlens substrate 6 being configured to project light emitted from the optical path adjustment structure 5 to the imaging position 4.

In an exemplary implementation, the first image is adjacent to the second image, the first image has a first border area close to the second image adjacent thereto, and the second image has a second border area close to the first image adjacent thereto. There may be an overlapping area between the first border area of the first image and the second border area of the second image, and an image displayed in the overlapping area of the first border area of the first image is the same as an image displayed in the overlapping area of the second border area of the second image, so that a seamless splicing of the first image and the adjacent second image is achieved.

In some embodiments, at least one first image is adjacent to at least one second image, the first image has a first edge close to the second image adjacent thereto, and the second image has a second edge close to the first image adjacent thereto. The first edge of the first image is adjacent to the second edge of the second image, so that a seamless splicing of the first image and the second image is achieved. Herein, the first edge of the first image is adjacent to the second edge of the second image, which means that there is no non-display area or display area between the first edge and the second edge, that is, there is no gap between the first edge of the first image and the second edge of the second image, and the first edge is seamlessly adjacent to the second edge.

In some embodiments, the near-eye display apparatus according to an embodiment of the present disclosure further includes a first optical element disposed between the first display unit 31 and the optical path adjustment structure 5. The first optical element may be a collimate lens, and the collimate lens can converge light emitted from the first display unit 31 to the optical path adjustment structure 5, thus reducing a light spot and improving display effect of the display apparatus.

In some embodiments, the near-eye display apparatus according to an embodiment of the present disclosure further includes a second optical element disposed between the second display unit 32 and the optical path adjustment structure 5. The second optical element may be a collimate lens, and the collimate lens can converge light emitted from the second display unit 32 to the optical path adjustment structure 5, thus reducing the light spot and improving the display effect of the display apparatus.

In the near-eye display apparatus according to an embodiment of the present disclosure, each display unit (for example, the first display unit 31 and the second display unit 32) forms different images (for example, the first image and the second image) in the imaging position 4. The outgoing light from each display unit converges at the imaging position 4, and when two beams of light with a certain width and a same angle enter the imaging position 4, they converge at a same imaging point at the imaging position 4. Light incident at different angles will converge at different imaging points at the imaging position 4. Therefore, by reasonably controlling the angle of light incident to the imaging position 4, images displayed by different display units can be seamlessly spliced at the imaging position 4 to form a complete display image.

The near-eye display apparatus according to an embodiment of the present disclosure seamlessly splices the first image formed by the first display unit 31 and the second image formed by the second display unit 32 to form a display image, so that an optical display with a large field of view and a high pixel density is achieved, the display graininess is reduced, an image definition viewed by a human eye is improved, and the purpose of improving a resolution of the near-eye display apparatus under a limit of an existing process is achieved.

The near-eye display apparatus according to an embodiment of the present disclosure makes the extension directions of the first display unit 31 and the second display unit 32 different, transmits the outgoing light from the first display unit 31 to the imaging position 4 to form the first image through the optical path adjustment structure 5, reflects the outgoing light from the second display unit 32 to the imaging position 4 to form the second image through the optical path adjustment structure 5, and seamlessly splices the first images and the adjacent second images, thereby eliminating a splicing gap problem caused by an image splicing and improving the display effect.

In an exemplary implementation, the near-eye display apparatus according to an embodiment of the present disclosure may include one or more first display units 31. For example, the near-eye display apparatus according to an embodiment of the present disclosure includes multiple first display units 31, each of the first display units 31 extends along the first direction X, and the multiple first display units 31 are arranged at intervals along the first direction X. FIG. 2 only illustrates a case where the near-eye display apparatus includes three first display units 31. In practical applications, the near-eye display apparatus may also include one, two or more first display units 31, and an embodiment of the present disclosure is not limited herein.

In an exemplary implementation, the near-eye display apparatus according to an embodiment of the present disclosure may include one or more second display units 32. For example, the near-eye display apparatus according to an embodiment of the present disclosure includes multiple second display units 32, each of the second display units 32 extends along the second direction Y, and the multiple second display units 32 are arranged at intervals along the second direction Y. FIG. 2 only illustrates a case where the near-eye display apparatus includes two second display units 32. In practical applications, the near-eye display apparatus may also include one, three or more second display units 32, and an embodiment of the present disclosure is not limited herein.

In an exemplary implementation, the near-eye display apparatus according to an embodiment of the present disclosure may include multiple first display units 31 and multiple second display units 32, each of the first display units 31 forms a first image at the imaging position 4, and each first image is not overlapped with each other; each of the second display units 32 forms a second image at the imaging position 4, and each second image is not overlapped with each other. The multiple first images and the multiple second images are alternately arranged along the first direction at the imaging position 4, and are seamlessly spliced to form a complete display image. Each first image and adjacent second image can be seamlessly spliced, for example, there is an overlapping area between the border area of the first image and the border area of the adjacent second image and an image displayed in the overlapping area of the border area of the first image is the same as an image displayed in the overlapping area of the border area of the adjacent second image, so that a seamless splicing of the first image and the adjacent second image is achieved. Specifically, a first image is formed at the imaging position 4 by the transmission of the outgoing light from a first display unit 31 through the optical path adjustment structure 5, and a second image is formed at the imaging position 4 by the reflection of the outgoing light from a second display unit 32 through the optical path adjustment structure 5. The first image is adjacent to the second image, the first image has a first border area close to the second image, the second image has a second border area close to the first image, there is an overlapping area between the first border area of the first image and the second border area of the second image, and an image displayed in the overlapping area of the first border area of the first image is the same as an image displayed in the overlapping area of the second border area of the second image. Outgoing light from a border area of the first display unit 31 close to the second display unit 32 is transmitted by the optical path adjustment structure 5 and emits in a direction toward the overlapping area, and outgoing light from a border area of the second display unit 32 away from the first display unit 31 is reflected by the optical path adjustment structure 5 and emits in the direction toward the overlapping area.

In an exemplary implementation, an area occupied in the first image and in the second image by the overlapping area in the near-eye display apparatus according to an embodiment of the present disclosure is not limited. For example, the overlapping area accounts for one fifth to one fiftieth of an area of the first image or an area of the second image.

In an exemplary implementation, as shown in FIG. 2, the first display unit 31 may be disposed oppositely to the imaging position 4, both the optical path adjustment structure 5 and the microlens substrate 6 are located between the first display unit 31 and the imaging position 4, and the optical path adjustment structure 5 is located on a side of the microlens substrate 6 close to the first display unit 31. At least a portion of the optical path adjustment structure 5 is located on the optical path of the outgoing light from the first display unit 31, and the outgoing light from the first display unit 31 can pass through the optical path adjustment structure 5 and the microlens substrate 6 sequentially to form the first image at the imaging position 4. The second display unit 32 is located on a side of the optical path adjustment structure 5 in the first direction, and an extension line of the second display unit 32 may intersect with an extension line of the imaging position 4. At least a portion of the optical path adjustment structure 5 is located on the optical path of the outgoing light from the second display unit 32, and the outgoing light from the second display unit 32 forms reflected light emitted in a direction toward the imaging position 4 through the optical path adjustment structure 5, and the reflected light passes through the microlens substrate 6 to form the second image at the imaging position 4.

In an exemplary implementation, as shown in FIG. 2, at least a portion of the outgoing light from the first display unit 31 passes through the optical path adjustment structure 5 and the microlens substrate 6 sequentially to form an overlapping area in the first image at the imaging position 4. Among the outgoing light from the second display unit 32, the optical path of the reflected light formed by at least a portion of the outgoing light through the optical path adjustment structure 5 is the same as the optical path of the light forming the overlapping area by the first display unit 31. The reflected light passes through the microlens substrate 6 and forms an overlapping area in the second image at the imaging position 4, so that an image displayed in the overlapping area by the first image is the same as an image displayed in the overlapping area by the second image.

In an exemplary implementation, each of the first display units 31 and the second display units 32 in the near-eye display apparatus according to an embodiment of the present disclosure may include at least one of an organic light emitting diode display unit, a quantum dot light emitting diode display unit, a micro light emitting diode display unit, and a liquid crystal display unit.

In an exemplary implementation, each of the first display units 31 and the second display units 32 in the near-eye display apparatus according to an embodiment of the present disclosure may include regular or irregular shapes, such as a triangle, a rectangle, a circle, a diamond, an ellipse, a polygon, which is not limited in the present disclosure.

In an exemplary implementation, a first display unit 31 and a second display unit 32 may each include multiple sub-pixels and the multiple sub-pixels may be configured to display a dynamic picture or a static image. For example, a first display unit 31 may include multiple pixel units arranged in a matrix matter, and a pixel unit may include a first sub-pixel emitting first color light, a second sub-pixel emitting second color light, and a third sub-pixel and a fourth sub-pixel emitting third color light. Each sub-pixel may include a pixel circuit and a light emitting element, the light emitting element in each sub-pixel is respectively connected with a pixel circuit of a sub-pixel where the light emitting element is located, the pixel circuit is configured to output a corresponding current to the light emitting element, and the light emitting element is configured to emit light with a corresponding brightness in response to the current output by the pixel circuit of the sub-pixel where the light emitting element is located.

FIG. 3 is a cross-sectional view of a first display unit in a near-eye display apparatus according to an embodiment of the present disclosure. FIG. 3 illustrates structures of three sub-pixels in the first display unit 31. As shown in FIG. 3, in a direction perpendicular to the first display unit 31, the first display unit 31 may include a base substrate 101, and a drive circuit layer 102, a light emitting structure layer 103, and an encapsulation structure layer 104 which are sequentially disposed on the base substrate 101. In some possible implementations, the display substrate may include another film layer, such as a touch structure layer, which is not limited in the present disclosure.

In an exemplary embodiment, the base substrate 101 may be a flexible base. The drive circuit layer 102 of each sub-pixel may include a pixel circuit composed of multiple transistors and capacitors. The light emitting structure layer 103 of each sub-pixel may at least include an anode 301, a pixel definition layer 302, an organic emitting layer 303 and a cathode 304. The anode 301 is connected to the pixel circuit, the organic emitting layer 303 is connected with the anode 301, the cathode 304 is connected to the organic emitting layer 303, and the organic emitting layer 303 emits light of a corresponding color under driving of the anode 301 and the cathode 304. The encapsulation structure layer 104 may include a first encapsulation layer 401, a second encapsulation layer 402, and a third encapsulation layer 403 which are stacked. The first encapsulation layer 401 and the third encapsulation layer 403 may be made of an inorganic material, the second encapsulation layer 402 may be made of an organic material, and the second encapsulation layer 402 is disposed between the first encapsulation layer 401 and the third encapsulation layer 403 to form a stacked structure of inorganic material/organic material/inorganic material, which can ensure that external moisture cannot enter the light emitting structure layer 103.

In an exemplary embodiment, a structure of the second display unit 32 may be the same as or different from a structure of the first display unit 31, which is not repeated in the present disclosure.

In an exemplary implementation, as shown in FIG. 2, the optical path adjustment structure 5 extends along a third direction. The optical path adjustment structure 5 is located between the first display unit 31 and the imaging position 4, and the optical path adjustment structure 5 is located on a side of the second display unit 32 in the first direction, the third direction being different from both the first direction and the second direction.

In an exemplary implementation, as shown in FIG. 2, the imaging position 4 may extend along a fourth direction, and the optical path adjustment structure 5 is located between the imaging position 4 and the first display unit 31. The fourth direction may be the same as the first direction, i.e., a plane where the imaging position 4 is located is parallel to a plane where the first display unit 31 is located. The fourth direction may be different from the second direction, i.e., the plane where the imaging position 4 is located intersects a plane where the second display unit 32 is located, for example the fourth direction may be perpendicular to the second direction.

FIG. 4 is a schematic diagram of a structure of an optical path adjustment structure in a near-eye display apparatus according to an embodiment of the present disclosure. In an exemplary implementation, as shown in FIG. 4, in a direction parallel to the optical path adjustment structure 5, the optical path adjustment structure 5 includes at least one semi-transmissive and semi-reflective region 510, at least one reflective region 520, and at least one transmissive region 530, and the semi-transmissive and semi-reflective region 510 is located between the reflective region 520 and the transmissive region 530.

In an exemplary implementation, the semi-transmissive and semi-reflective region 510 is located on an optical path of at least a portion of the outgoing light from the first display unit 31 and on an optical path of at least a portion of the outgoing light from the second display unit 32. The semi-transmissive and semi-reflective region 510 is configured to transmit at least a portion of the outgoing light from the first display unit 31 in the direction toward the imaging position 4 and to reflect at least a portion of the outgoing light from the second display unit 32 in the direction toward the imaging position 4.

FIG. 6 is a schematic diagram of an optical path in a near-eye display apparatus according to an embodiment of the present disclosure. In an exemplary implementation, an optical path of outgoing light from a first display unit 31 is taken as an example. As shown in FIG. 6, the optical path of the outgoing light from the first display unit 31 after being transmitted by the semi-transmissive and semi-reflective region 510 is the same as the optical path of the outgoing light from the second display unit 32 after being reflected by the semi-transmissive and semi-reflective region 510. The outgoing light from the first display unit 31 and the outgoing light from the second display unit 32 with the same optical path pass through the microlens substrate 6 and then are transmitted to the imaging position 4 to form an overlapping area, and images displayed in the overlapping area are the same.

In an exemplary implementation, as shown in FIGS. 2 and 4, the reflective region 520 is located on a side of the semi-transmissive and semi-reflective region 510 and the reflective region 520 is located on the optical path of at least a portion of the outgoing light from the second display unit 32. The reflective region 520 is configured to reflect at least a portion of the outgoing light from the second display unit 32 toward an area other than the overlapping area in the second image. The outgoing light from the second display unit 32 reflected by the reflective region 520 passes through the microlens substrate 6 and then is transmitted to the imaging position 4 to form an area other than the overlapping area in the second image. An imaging area formed at the imaging position 4 by the outgoing light from the second display unit 32 reflected by the reflective region 520 and an overlapping area formed at the imaging position 4 by the outgoing light from the second display unit 32 reflected by an adjacent semi-transmissive and semi-reflective region 510 combine to form a second image.

In an exemplary implementation, as shown in FIGS. 2 and 4, the transmissive region 530 is located on a side of the semi-transmissive and semi-reflective region 510 away from the reflective region 520 and the transmissive region 530 is located on the optical path of at least a portion of the outgoing light from the first display unit 31. The transmissive region 530 is configured to transmit at least a portion of the outgoing light from the first display unit 31 toward an area other than the overlapping area in the first image. The outgoing light from the first display unit 31 transmitted by the transmissive region 530 passes through the microlens substrate 6 and then is transmitted to the imaging position 4 to form an area other than the overlapping area in the first image. An imaging area formed at the imaging position 4 by the outgoing light from the first display unit 31 transmitted by the transmissive region 530 and an overlapping area formed at the imaging position 4 by the outgoing light from the first display unit 31 transmitted by an adjacent semi-transmissive and semi-reflective region 510 combine to form a first image.

In an exemplary implementation, as shown in FIG. 4, in a direction perpendicular to the optical path adjustment structure 5, the optical path adjustment structure 5 includes a substrate 54 and at least one semi-transmissive and semi-reflective film 51, at least one reflective film 52 and at least one anti-reflection film 53 disposed on the substrate 54, and the semi-transmissive and semi-reflective film 51 is disposed between the reflective film 52 and the anti-reflection film 53. The semi-transmissive and semi-reflective film 51 is located in the semi-transmissive and semi-reflective region 510 and the semi-transmissive and semi-reflective film 51 is located on the optical path of at least a portion of the outgoing light from the first display unit 31 and on the optical path of at least a portion of the outgoing light from the second display unit 32. The reflective film 52 is located in the reflective region 520 and the reflective film 52 is located on the optical path of at least a portion of the outgoing light from the second display unit 32. The anti-reflection film 53 is located in the transmissive region 530 and the anti-reflection film 53 is located on the optical path of at least a portion of the outgoing light from the first display unit 31.

It should be noted that, in this embodiment, a ratio of transmission to reflection (referred to as transmission-reflection ratio) for the semi-transmissive and semi-reflective film 51 may be in a variety of combinations, and is not limited to a case that half is transmission and half is reflection (that is, the transmission-reflection ratio is 50% to 50%), but also includes other cases of transmission-reflection ratios such as 30% to 70% or 60% to 90%. The specific transmission-reflection ratio is configured according to actual needs of the optical system, and is not specifically limited herein.

In an exemplary implementation, as shown in FIG. 4, the substrate 54 in the optical path adjustment structure 5 may be made of a light-transmitting material such as glass or plastic.

In an exemplary implementation, as shown in FIG. 4, a thickness range of the optical path adjustment structure 5 may be from 1 mm to 10 mm, for example the thickness range of the optical path adjustment structure 5 may be from 1 mm to 5 mm.

In an exemplary implementation, as shown in FIG. 2, in the near-eye display apparatus according to an embodiment of the present disclosure, the microlens substrate 6 is located between the optical path adjustment structure 5 and the imaging position 4 and the outgoing light from the optical path adjustment structure 5 passes through the microlens substrate 6 and then is projected to the imaging position 4. For example, the outgoing light from the second display unit 32 is reflected to the microlens substrate 6 by the optical path adjustment structure 5, and passes through the microlens substrate 6 to form a parallel light to be emitted to the imaging position 4.

In an exemplary implementation, the microlens substrate 6 includes multiple microlenses and the multiple microlenses are located on a side close to the imaging position 4. The microlenses are microlenses with image magnification and parallel projection functions. The outgoing light from a first display unit 31 is transmitted by the optical path adjustment structure 5 and then incidents into a microlens; the outgoing light from a second display unit 32 is reflected by the optical path adjustment structure 5 and then incidents into a microlens; and a portion of the outgoing light from the first display unit 31 and a portion of the outgoing light from the second display unit 32 may share a microlens to form an overlapping area at the imaging position 4.

In an exemplary implementation, the microlens according to an embodiment of the present disclosure may be a microconvex lens and the microconvex lens has a small focal length (e.g. 2 mm-3 mm), thereby reducing a thickness and weight of the near-eye display apparatus.

In an exemplary implementation, an aperture of the microlens according to an embodiment of the present disclosure is not limited and for example, the microlens may reach the micron level.

In an exemplary implementation, the microlens according to an embodiment of the present disclosure includes at least one of a spherical lens, an aspherical lens, and a free-form lens.

In an exemplary implementation, the microlens according to an embodiment of the present disclosure may be an aspherical lens and a radius of curvature of the aspherical lens continuously varies from a center to an edge of the curvature, so that good aberration correction may be maintained to achieve desired performance. The application of the aspherical lens brings excellent sharpness and higher resolution, and moreover, makes a miniaturization design of the lens possible.

In an exemplary implementation, the microlens according to an embodiment of the present disclosure may be made of a light-transmitting material such as glass or plastic.

In an exemplary implementation, the microlens substrate 6 further includes an anti-reflection structure and the anti-reflection structure is disposed on a side of the multiple microlenses close to the optical path adjustment structure 5; and/or, the anti-reflection structure is disposed on a side of the multiple microlenses away from the optical path adjustment structure 5. The anti-reflection structure is used to increase transmittance of microlens and improve the imaging effect.

In an exemplary implementation, as shown in FIG. 2, there is a first space capable of transmitting light between adjacent first display units 31, a second space capable of transmitting light between adjacent second display units 32, and a third space capable of transmitting light between adjacent microlenses. External ambient light can enter the imaging position 4 from the first space, the second space, and the third space, so that the imaging position 4 can simultaneously display a first image, a second image, and an external object, thereby augmenting reality display.

In an exemplary implementation, as shown in FIG. 2, the imaging position 4 may be a human eye box area. The human eye box area may have an area of 50 square millimeters to 120 square millimeters, for example, the human eye box area may have an area of 64 square millimeters to 100 square millimeters.

In an exemplary implementation, the imaging position 4 may take a variety of shapes, for example regular or irregular shapes, such as triangles, rectangles, circles, diamonds, ellipses, polygons, which are not limited herein.

In an exemplary implementation, the imaging position 4 may be rectangular, a length of the imaging position 4 may be from 8 mm to 10 mm, and a width of the imaging position 4 may be from 8 mm to 10 mm.

In an exemplary implementation, a field angle of view of the imaging position 4 may be from 80° to 170°, for example, the field angle of view of the imaging position 4 may be from 100° to 150°. A minimum distance between the imaging position 4 and multiple microlenses is from 15 mm to 20 mm.

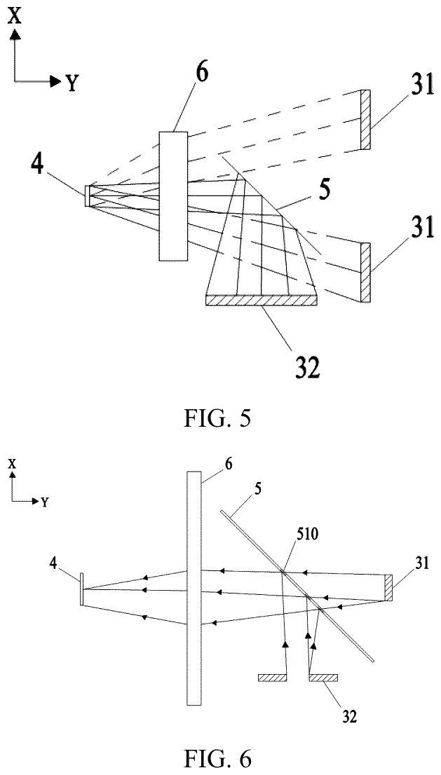

FIG. 5 is a second schematic diagram of a structure of a near-eye display apparatus according to the present disclosure. In an exemplary implementation, as shown in FIG. 5, the near-eye display apparatus according to an embodiment of the present disclosure includes two first display units 31 and one second display unit 32. Two first display units 31 each extend along a first direction (for example, direction X), and are arranged at intervals along the first direction. A portion of the outgoing light from the two first display units 31 is transmitted through the optical path adjustment structure 5 and incidents into the microlens substrate 6, and a portion of the outgoing light from the two first display units 31 incidents directly into the microlens substrate 6. After the two portions of the outgoing light pass through the microlens substrate 6, two first images are formed at the imaging position 4, and the two first images may be arranged at intervals along the first direction. The second display unit 32 extends along a second direction (for example, direction Y). The outgoing light from the second display unit 32 may be reflected by the optical path adjustment structure 5 and form a second image at the imaging position 4 after passing through the microlens substrate 6. The second image is located between the two first images and the second image is seamlessly spliced with the two first images to form a complete display image. Herein, the first direction is different from the second direction. For example, the first direction is perpendicular to the second direction.

An embodiment of the present disclosure also provides a display method of a near-eye display apparatus and the near-eye display apparatus can be the near-eye display apparatus according to any one of the aforementioned embodiments. The near-eye display apparatus includes at least one first display unit, at least one second display unit, and an optical path adjustment structure, an extension direction of the first display unit being different from an extension direction of the second display unit; at least a portion of the optical path adjustment structure being located on an optical path of outgoing light from the first display unit and on an optical path of outgoing light from the second display unit; the display method of the near-eye display apparatus includes:
transmitting at least a portion of the outgoing light from the first display unit through the light path adjustment structure to emit in a direction toward an imaging position, so that the outgoing light from the first display unit forms a first image at the imaging position;
reflecting at least a portion of the outgoing light from the second display unit through the light path adjustment structure to emit in the direction toward the imaging position, so that the outgoing light from the second display unit forms a second image at the imaging position; and
splicing the first image and the second image to form a display image.

An embodiment of the present disclosure also provides a wearable device, which includes the near-eye display apparatus according to any one of the embodiments described above. The wearable device can be a variety of head-mounted smart devices, such as smart glasses, smart helmets, to realize VR display or AR display. An embodiment of the present application does not specifically limit a specific form of the above wearable device.

The drawings of the present disclosure only involve structures involved in the present disclosure, and other structures may refer to conventional designs. The embodiments of the present disclosure, i.e., features in the embodiments, may be combined with each other to obtain new embodiments if there is no conflict.

Those of ordinary skills in the art should understand that modifications or equivalent replacements may be made to the technical solutions of the present disclosure without departing from the essence and scope of the technical solutions of the present disclosure, and shall all fall within the scope of the claims of the present disclosure.

1. A near-eye display apparatus, comprising:
at least one first display unit, wherein the first display unit extends along a first direction and the first display unit is configured to form a first image at an imaging position;
at least one second display unit, wherein the second display unit extends along a second direction and the second display unit is configured to form a second image at the imaging position; the first direction is different from the second direction;
the first image and the second image are spliced to form a display image;
an optical path adjustment structure, wherein at least a portion of the optical path adjustment structure is located on an optical path of outgoing light from the first display unit and on an optical path of outgoing light from the second display unit, the optical path adjustment structure is configured to transmit at least a portion of the outgoing light from the first display unit in a direction toward the imaging position, and reflect at least a portion of the outgoing light from the second display unit in the direction toward the imaging position.

2. The near-eye display apparatus according to claim 1, wherein the first image has a first border area close to the second image adjacent thereto, the second image has a second border area close to the first image adjacent thereto, there is an overlapping area between the first border area and the second border area, and an image displayed in the overlapping area of the first border area is the same as an image displayed in the overlapping area of the second border area.

3. The near-eye display apparatus according to claim 1, wherein the first image has a first edge close to the second image adjacent thereto, the second image has a second edge close to the first image adjacent thereto, and the first edge is adjacent to the second edge so that the first image and the second image are seamlessly spliced.

4. The near-eye display apparatus according to claim 1, wherein the optical path adjustment structure comprises at least one semi-transmissive and semi-reflective region, the semi-transmissive and semi-reflective region is located on an optical path of at least a portion of the outgoing light from the first display unit and on an optical path of at least a portion of the outgoing light from the second display unit, the semi-transmissive and semi-reflective region is configured to transmit at least a portion of the outgoing light from the first display unit in the direction toward the imaging position and reflect at least a portion of the outgoing light from the second display unit in the direction toward the imaging position.

5. The near-eye display apparatus according to claim 4, wherein the optical path adjustment structure further comprises at least one reflective region, the reflective region is located on a side of the semi-transmissive and semi-reflective region, the reflective region is located on the optical path of at least a portion of the outgoing light from the second display unit, and the reflective region is configured to reflect at least a portion of the outgoing light from the second display unit in the direction toward the imaging position.

6. The near-eye display apparatus according to claim 5, wherein the optical path adjustment structure further comprises at least one transmissive region, the transmissive region is located on a side of the semi-transmissive and semi-reflective region away from the reflective region, the transmissive region is located on the optical path of at least a portion of the outgoing light from the first display unit, and the transmissive region is configured to transmit at least a portion of the outgoing light from the first display unit in the direction toward the imaging position.

7. The near-eye display apparatus according to claim 6, wherein the optical path adjustment structure comprises a substrate and at least one semi-transmissive and semi-reflective film, at least one reflective film and at least one anti-reflection film disposed on the substrate, the semi-transmissive and semi-reflective film is located in the semi-transmissive and semi-reflective region, the reflective film is located in the reflective region, and the anti-reflection film is located in the transmissive region.

8. The near-eye display apparatus according to claim 7, wherein the semi-transmissive and semi-reflective film is disposed between the reflective film and the anti-reflection film.

9. The near-eye display apparatus according to claim 8, wherein the substrate of the optical path adjustment structure is made of glass or plastic.

10. The near-eye display apparatus according to claim 1, wherein the optical path adjustment structure has a thickness ranging from 1 mm to 5 mm.

11. The near-eye display apparatus according to claim 1, wherein the optical path adjustment structure extends along a third direction and the third direction is different from both the first direction and the second direction.

12. The near-eye display apparatus according to claim 1, further comprising a microlens substrate, wherein the microlens substrate comprises a plurality of microlenses, the plurality of microlenses are located between the optical path adjustment structure and the imaging position, the plurality of microlenses are configured to project at least a portion of outgoing light from the optical path adjustment structure to the imaging position.

13. The near-eye display apparatus according to claim 1312, wherein the plurality of microlenses comprise at least one of a spherical lens, an aspherical lens, and a free-form lens.

14. The near-eye display apparatus according to claim 13, wherein the microlens substrate further comprises an anti-reflection structure, the anti-reflection structure is disposed on a side of the plurality of microlenses close to the optical path adjustment structure; and/or, the anti-reflection structure is disposed on a side of the plurality of microlenses away from the optical path adjustment structure.

15. The near-eye display apparatus according to claim 1, wherein a field angle of view of the imaging position is from 100° to 150°.

16. The near-eye display apparatus according to claim 1, wherein both the first display unit and the second display unit comprise at least one of an organic light emitting diode display unit, a quantum dot light emitting diode display unit, a micro light emitting diode display unit, and a liquid crystal display unit.

17. A wearable device, comprising the near-eye display apparatus according to claim 1.

18. A display method of a near-eye display apparatus, wherein the near-eye display apparatus comprises at least one first display unit, at least one second display unit, and an optical path adjustment structure, an extension direction of the first display unit is different from an extension direction of the second display unit; at least a portion of the optical path adjustment structure is located on an optical path of outgoing light from the first display unit and on an optical path of outgoing light from the second display unit; the display method of the near-eye display apparatus comprises:
transmitting at least a portion of the outgoing light from the first display unit through the light path adjustment structure to emit in a direction toward the imaging position, so that the outgoing light from the first display unit forms a first image at the imaging position;
reflecting at least a portion of the outgoing light from the second display unit through the light path adjustment structure to emit in the direction toward the imaging position, so that the outgoing light from the second display unit forms a second image at the imaging position; and
splicing the first image and the second image to form a display image.

19. The near-eye display apparatus according to claim 2, wherein the optical path adjustment structure has a thickness ranging from 1 mm to 5 mm.

20. The near-eye display apparatus according to claim 2, wherein the optical path adjustment structure extends along a third direction and the third direction is different from both the first direction and the second direction.
